(19) United States
(12) Patent Application Publication
(10) Pub. No.: US 2006/0048391 A1
(43) Pub. Date: Mar. 9, 2006

(54) Close cut cutting instrument

(76) Inventor: Joseph Bellissimo, Canoga Park, CA (US)

Correspondence Address: Marshall E. Rosenberg, Esq.;Registered Patent Attorney, The Gilbert Law Building, 22130 Clarendon Street, Woodland Hills, CA, 91367, US

(21) Appl. No.: 10/936,766

(22) Filed: Sep. 8, 2004

(51) Int. Cl. B26B 13/22

(52) U.S. Cl. 30/134

(57) ABSTRACT

A binding cutter for severing bindings such as wire, nylon or other tightly tensioned materials is disclosed. The cutter is provided with enclosed gripping and cutting portions supported within the jaws of the cutter. The outer faces of the jaws including camming surfaces extending from jaw tips to enable easy gripping of the wire to be cut, such that when the cutter is closed in the direction of the cutting action, the wire is urged up and away from the backing board into the concavity defined by the jaws and supported for gripping by gripping portions and cutting by cutting blades into the relatively small, confined concavity. The inventive apparatus thus is readily used for snaring tightly tensioned package bindings of most any material, and the bindings supported by the internal gripping portions are supported to enable a clean, severing cut.

### CROSS-REFERENCE TO RELATED APPLICATIONS

not applicable

### STATEMENT RE: FEDERALLY SPONSORED RESEARCH/DEVELOPMENT:

not applicable

### BACKGROUND OF THE INVENTION

1. Field of the Invention

The present invention relates to hand tools, and more particularly, to close cut package binding clippers for severing closely configured package bindings, especially small gage bindings such as those used to tether small items to backing boards and display panels.

2. Description of the Related Art

This invention relates generally to a hand tools, and, more particularly, to a light weight, hand-held wire or other binding cutter. While the term wire cutter is used herein to describe the hand tool, it will be understood that other functions (such as wire stripping or gripping) other than just wire cutting can be incorporated into the tool, and accordingly, the term wire cutter is not to be construed as limiting the tool to just the cutting function.

Countless consumer goods are offered for retail demonstration and display by being mounted to backing boards, product enclosures, and other structures to support the product for display, transport, and presentation. Commonly, significant quantities of wire and string bindings are utilized to secure the products, oftentimes with what appears to be significant redundancy. One product category that appears to welcome such vigorous overuse of binding materials is the consumer toy industry, which endeavors to support the product for ready display while minimizing the apparent presence of the bindings utilized to restrain the product in place. By way of example, a toy doll having an anthropomorphic structure will likely be secured to a backing board and package with numerous bindings for supporting arms, legs, torso, and neck, the binding commonly extending about the anthropomorphic structure to be tied at the back of the package. As many as a dozen or more bindings may be utilized for a toy of average size, with more bindings utilized for larger toy sizes and accessories provided with the toy.

As many parents and other care-givers know only too well, removing such bindings becomes an arduous and painstakingly lengthy process, due not only to the redundancy of the package bindings, but also to the tightly bound bindings used with increasing frequency. In addition, such bindings may be wire, nylon or cotton string or cord, or indeed any other material that securely retains the product in place, but which inherently requires some tool for cutting the bindings. As most consumers are also aware, most bindings are not readily undone manually because those bindings are commonly tensioned directly against the backing board to which the product is mounted. Accordingly, and commonly, a pair of scissors or other typically inappropriate tool is employed in a digging and leveraging manner that not only causes gouging of the packaging, but quite possibly to the product mounted thereto, in an uncontrolled manner wherein the final severing action typically is an uncontrolled slicing action past the severed binding.

Since package opening in a consumer-oriented society is a task performed relatively frequently, it is desirable to have a cutting tool that readily engages the package bindings, even those bindings tensioned tightly to the backing board or other mounting or packaging structure, without damaging the product contents. The related art at best provides wire cutters having a narrow thickness that provides only a small gripping surface at its nose for gripping the wires during the twisting/untwisting process, and fail to provide a cutting structure that does not contribute to the gouging action caused thereby.

Accordingly, there exists a need for a binding cutter is readily usable for cutting package bindings used in all manner of packaging, and overcomes the substantial shortcomings of the prior art, while maintaining portability, compactness, and safety of the tool.

### OBJECTS AND SUMMARY OF THE INVENTION

Accordingly, it is an object of the present invention to provide an apparatus for cutting package bindings in a manner that is non-destructive to the associated packaging.

It is another object of the present invention to provide a cutting apparatus that is readily usable even for package bindings that are tightly tensioned virtually flush against a packaging or backing board, panel, or other packaging structure.

It is a further object of the present invention to provide an improved cutting device for provides significant mechanical advantage for cutting tougher bindings, yet prevents against unintended harm to the basis packaging.

It is a further object of the present invention to provide a power assisted hand tool constructed with the present invention.

According to the present invention, a cutter is provided having enclosed gripping and cutting portions supported within the jaws of the cutter. The outer faces of the jaws including camming surfaces extending from jaw tips to enable easy gripping of the wire to be cut, such that when the cutter is closed in the direction of the cutting action, the wire is urged up and away from the backing board into the concavity defined by the jaws and supported for gripping by gripping portions and cutting by cutting blades into the relatively small, confined concavity. The inventive apparatus thus is readily used for snaring tightly tensioned package bindings of most any material, and the bindings supported by the internal gripping portions are supported to enable a clean, severing cut, and optionally, retaining the severed ends following the cutting action to enable the user the opportunity to controllably remove the item from the backing board

### BRIEF DESCRIPTION OF THE DRAWINGS

FIG. 1 is a perspective view of a mounting or backing board supporting a product bound in place by a plurality of bindings for which removal is achieved by the device of the present invention.

FIG. 2 is an elevational view of the inventive tool shown in the fully closed position.

FIG. 3 is a partial elevational view of the tool shown in FIG. 1, shown in a fully opened position for accommodating a binding to be severed.

FIG. 4 is a sectional view taken along line 4-4 of FIG. 2, showing the tool in a partially closed position with the cutting blades shown in an overlapping position.

FIG. 5 is a sectional view similar to that shown in FIG. 5, showing the tool engaging a binding to be severed, the binding shown partially severed and prior to gripping by the gripping portions.

FIG. 6 is an isometric view of the tool shown in FIG. 3, showing the jaw tips supporting and urging the binding upwardly into the cutter concavity prior to cutting, the camming surfaces engaging against the mounting or backing board.

FIG. 7 is a partial elevational view of the cutter of the present invention further initiating the cutting action, the binding being gripped by the opposing gripping portions as the jaw portions are cammed up and away from the binding/mounting board.

FIG. 8 is a sectional view showing further cutting progress relative to that shown in FIG. 5.

### DETAILED DESCRIPTION OF THE PREFERRED EMBODIMENTS

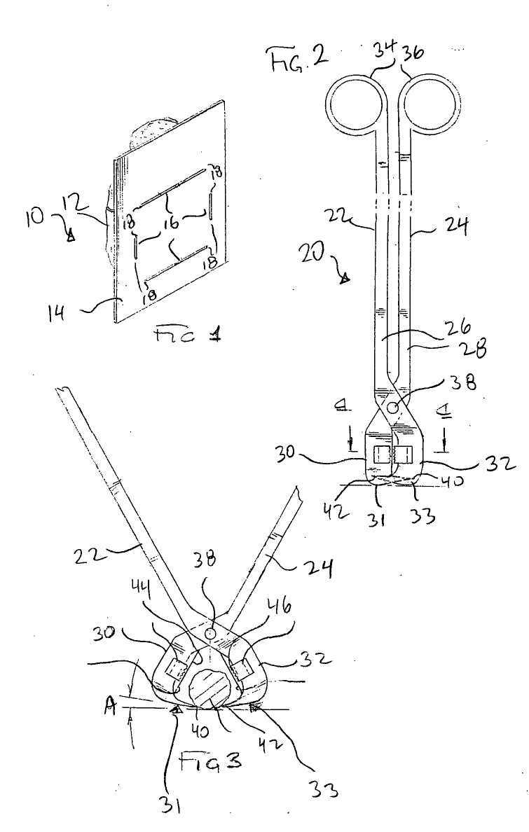

Referring now to the drawings wherein like numerals designate like and corresponding parts throughout the several views, FIG. 1 shows the assembly 10 of a product 12 mounted to a mounting or backing board 14 by a plurality of bindings 16 as is common to the packaging arts. Specifically, the product 12 is conventionally secured at a plurality of mounting points corresponding to a like number of bindings 16 projected through mounting holes 18 as necessary and desirable to secure the product for shipping and display. Commonly, the bindings 16 are a relatively thin gage wire, plastic or twine material that is suitable for providing the necessary support, yet which is thin enough to not detract from the overall presentation especially when provided in display mounting. It is to be understood, however, that the selected bindings are typically of high strength and not amenable to manual rupturing by the consumer, without use of a tool in the manner previously described above in connection with the related art.

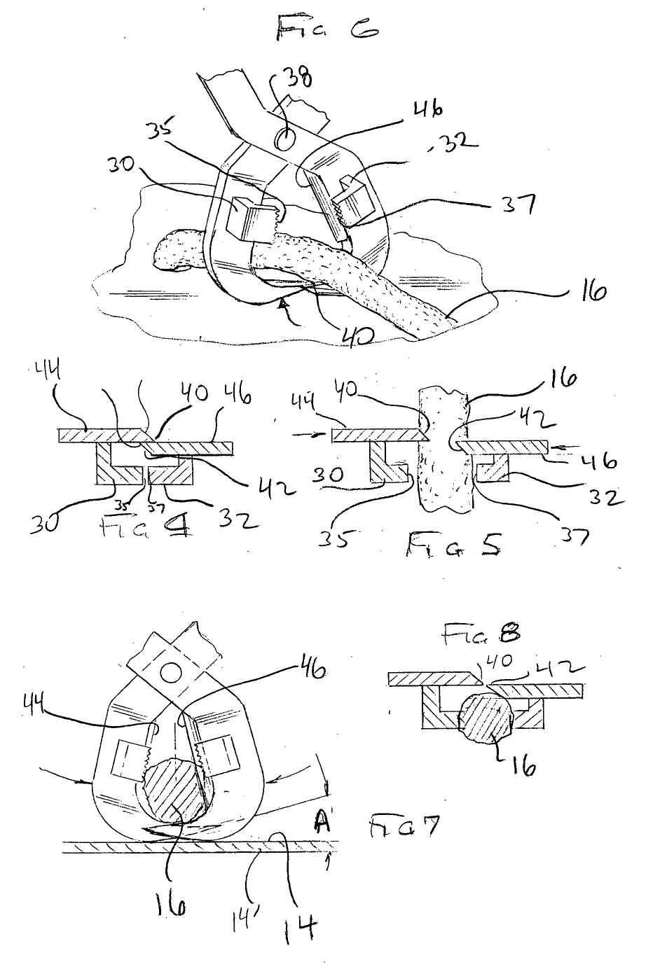

With reference now to FIGS. 2-8, the close cut cutting instrument 20 (hereinafter “cutter”) of the present invention is shown. According to the present invention, the cutter 20 includes first and second elongated members 22, 24 having handle portions 26, 28 and jaw portions 30, 32, respectively, at opposite end thereof. Handle portions 26, 28 are terminated at handles 34, 36, respectively, with open or closed (as shown) configurations. Elongated members 22, 24 are mounted for pivoting action by pivot point 38, or alternatively for articulating action (not shown) as will be apparent to the skilled artisan, including but not limited to a pivot and slide arrangement as may be found in open pliers constructions and as may be utilized with the present invention to accommodate oversized bindings.

Jaw portions 30, 32 each have an outer camming surface 31, 33 extending from the bottom surface thereof, for use in the manner to be more fully described below. Camming surfaces 31, 33 engage the mounting board 14 in a manner such that when jaw tips 40, 42 extending from jaw portions 30, 32, respectively, engage binding 16, the binding 16 is urged away from the mounting board 14.

With reference to FIGS. 3 and 6, each jaw portion includes a blade 44, 46, respectively mounted in opposing relationship. Blades 44, 46 are sized, shaped and sharpened to provide an effective bite and cut, and to simultaneously sever the complete binding introduced thereto to achieve the desired one step “snipping” action of the present invention. As will be appreciated by the skilled artisan, blades 44, 46 may be curved, square, or have a compound shape to meet specified cutting criteria.

Further, gripping portions 48, 50 are provided parallel to but offset from the blades 44, 46. The gripping portions 48, 50 cooperatively grip the binding 16 preliminary to, during, and after cutting by blades 44, 46, when the jaw portions 30, 32 are brought into opposing registration. Alternatively, relative placement of the gripping portions 48, 50 may be made such that secure grip occurs during the final cutting stages of the binding 16, further securing the cut ends of the binding 16 to enable user disposal of the cut binding. Gripping portions 46, 50 are either integrally formed with jaw portions 30, 32, or added thereto by welding, soldering, or fastener connection, and may include a textured face surface 35, 37 (such as a “waffle” or “ridged” pattern) to better grip a binding 16. Thus, the gripping portions 48, 50 grip the wire concurrently with lifting of the binding 16 by opposition of the camming surfaces 31, 33 adjacent to the binding 16.

With reference now to FIGS. 4, 5 and 8, blades 44, 46 are positioned to engage and sever a binding 16 introduced thereto during camming action by the jaw portions 30, 32, although the device is fully operative even without utilization of the novel camming action of the present invention. It is contemplated that the camming action operates though angle A, in the range of about 10 degrees to about 30 degrees tangent to a flush surface of the backing board surface. It is by virtue of the camming action through angle A that the binding 16 is captured by In either case, the jaw of the inventive device is designed to open sufficiently wide to accept a binding 16 with a nominal diameter of up to about 0.5 inches, although a greater or lesser jaw may opening may be provided as necessary and desired. Given the geometry of the device 20, the pivot point 38 is provided no further away than about 0.5 inches from the upper portion of the jaws, to provide a limited opening range with necessary mechanical advantage in easily cutting tougher binding materials.

In connection with the present invention, a self-biasing mechanism such as a spring may be provided to maintain the inventive device in the closed position during periods of non use. Alternatively, a latching mechanism may be provided to provide such a safety measure. Also, the wire cutter of the present invention may be provided as part of a promotional assembly, by being readily secured to the package having a closure amenable to be severed by the cutter, or may be grouped with one or more related or unrelated packaged items in the manner of providing enhanced and additional value to the consumer.

It is to be understood that the present invention is not limited to the embodiments described above, but encompasses any and all embodiments within the scope of the following claims.

What I claim is:

1. A hand-held wire cutter, comprising:
a first elongated member having a handle portion and a jaw portion, the jaw portion having an outer camming surface;
a second elongated member having a handle portion and a jaw portion, the jaw portion having an outer camming surface, the second elongated member being pivotably connected to the first elongated member for allowing the jaw portion of the first elongated member and the jaw portion of the second elongated member to cooperatively move between an opened position and a closed position;
the jaw portions each having a cutting surface for cutting a wire;
the jaw portions each having a gripping portion for cooperatively gripping the wire at least during wire cutting, the jaw portions brought into opposing registration to grip the wire concurrently with lifting of the wire by opposition of the camming surfaces adjacent to the wire.

2. The hand-held wire cutter as recited in claim 1 wherein the jaw portions of the first and second elongated members each have cutting surfaces for cutting the wire.

3. The hand-held wire cutter as recited in claim 1, wherein the cutting surfaces are supported in opposing relationship within a concavity defined by the jaw portions.

4. The hand-held wire cutter as recited in claim 1, wherein the gripping portions are supported in opposing relationship within a concavity defined by the jaw portions.

5. The hand-held wire cutter as recited in claim 1, wherein the leading edges of each jaw portion has an engaging tip, the engaging tips positioned to cooperatively engage a circumferential aspect of the wire when the camming surfaces are positioned substantially flush with a wire mounting surface, the engaging tips urging the wire into a concavity defined by the jaw portions when the jaw portions are further closed to cause the camming surfaces to progressively act with a camming action against the wire mounting surface to deliver the wire into a gripping and cutting position.

6. The hand-held wire cutter as recited in claim 5, wherein the gripping and cutting position is achieved when the camming surfaces are each currently positioned at an angle in a range of about 10 degrees to about 30 degrees relative to the wire mounting surface.

7. The hand-held wire cutter as recited in claim 6, wherein the jaw tips engage the wire when the camming surfaces are at an angle substantially acute or parallel to the wire mounting surface.

8. The hand-held wire cutter as recited in claim 1, further comprising a closing apparatus to bias the jaws in a closed position when not in operation.

9. A cutter for severing a wire, comprising:
a first elongated member having a handle portion and a jaw portion, the jaw portion having an outer camming surface at a jaw portion substantially opposite the handle portion;
a second elongated member having a handle portion and a jaw portion, the jaw portion having an outer camming surface at a jaw portion substantially opposite the handle portion, the second elongated member being connected for articulation to the first elongated member for allowing the jaw portion of the first elongated member and the jaw portion of the second elongated member to cooperatively move between an opened position and a closed position;
the jaw portions each having a cutting surface for acting in cooperation to cut a wire;
the jaw portions each having a gripping portion for acting in cooperation to grip the wire during part of the process of wire cutting, the jaw portions brought into opposing registration to grip the wire concurrently with lifting of the wire by opposing portions of the jaw portions.

10. The cutter as recited in claim 9, wherein the wire is raised into cutting position during concurrent closure of the jaw portions about the camming surfaces adjacent to the wire.

11. The cutter as recited in claim 9 wherein the jaw portions of the first and second elongated members each have cutting surfaces for cutting the wire.

12. The cutter as recited in claim 11, wherein the cutting surfaces are supported in opposing relationship within a concavity defined by the jaw portions.

13. The cutter as recited in claim 11, wherein the gripping portions are supported in opposing relationship within a concavity defined by the jaw portions.

14. The cutter as recited in claim 11, wherein the leading edges of each jaw portion has an engaging tip, the engaging tips positioned to cooperatively engage a circumferential aspect of the wire when the camming surfaces are positioned substantially flush with a wire mounting surface, the engaging tips urging the wire into a concavity defined by the jaw portions when the jaw portions are further closed to cause the camming surfaces to progressively act with a camming action against the wire mounting surface to deliver the wire into a gripping and cutting position.

15. The cutter as recited in claim 14, wherein the gripping and cutting position is achieved when the camming surfaces are each currently positioned at an angle in a range of about 10 degrees to about 30 degrees relative to the wire mounting surface.

16. The cutter as recited in claim 9, wherein the elongated members are supported for articulation about a pivot adjacent the jaws.

17. The cutter as recited in claim 9, further comprising a locking latch pivotably mounted on a selected one of said elongated members for locking the cutter in a closed position.

18. The cutter as recited in claim 9, wherein the elongated members are supported by handles.

19. The cutter as recited in claim 9, wherein the handles are power assisted.

20. A kit, comprising:
a package having a wire closure to be severed; and
a hand-held wire cutter provided with the package for severing the wire closure, the cutter including:
a first elongated member having a handle portion and a jaw portion, the jaw portion having an outer camming surface;
a second elongated member having a handle portion and a jaw portion, the jaw portion having an outer camming surface, the second elongated member being pivotably connected to the first elongated member for allowing the jaw portion of the first elongated member and the jaw portion of the second elongated member to cooperatively move between an opened position and a closed position;
the jaw portions each having a cutting surface for cutting a wire;
the jaw portions each having a gripping portion for cooperatively gripping the wire at least during wire cutting, the jaw portions brought into opposing registration to grip the wire concurrently with lifting of the wire by opposition of the camming surfaces adjacent to the wire.

21. The kit recited in claim 21, wherein the wire cutter is provided as a promotional item.
